(19) United States
(12) Patent Application Publication
(10) Pub. No.: US 2015/0186011 A1
(43) Pub. Date: Jul. 2, 2015

(54) APPARATUS AND METHOD FOR INTERACTING WITH ITEMS ON A PORTABLE TERMINAL

(71) Applicant: Samsung Electronics Co., Ltd., Suwon-si (KR)

(72) Inventors: William Stryker CLAUSEN, Kirkland, WA (US); Zhiyun LI, Kenmore, WA (US); Ashish VERMA, Issaquah, WA (US)

(73) Assignee: Samsung Electronics Co., Ltd., Suwon-si (KR)

(21) Appl. No.: 14/143,796

(22) Filed: Dec. 30, 2013

(51) Int. Cl. G06F 3/0484; G06F 3/0488

(52) U.S. Cl. CPC G06F 3/04842; G06F 3/0488

(57) ABSTRACT

An apparatus and method for selecting items on a portable terminal are provided. The method includes receiving an input for rearranging at least one item on a User Interface (UI), and rearranging and displaying on a screen the at least one item on the UI. The at least one rearranged item is rearranged so as to be displayed in a position that is different from an original position of the at least one rearranged item in relation to a remaining portion of the UI.

### TECHNICAL FIELD

The present disclosure relates to an apparatus and method for interacting with items on a portable terminal. More particularly, the present disclosure relates to an apparatus and method for rearranging items displayed on a User Interface (UI) of a portable terminal for facilitating selection of items.

### BACKGROUND

Portable terminals are developed to provide wireless communication between users. As technology has advanced, portable terminals now provide many additional features beyond simple telephone conversation. For example, portable terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a portable terminal has effectively become a necessity of daily life.

According to the related art, portable terminals may be equipped with a touchscreen. In addition to providing a display functionality such as displaying a User Interface (UI), the touchscreen allows a user to provide input to the portable terminal. For example, the UI may display at least one item with which a user may interact. The item may be an image, a hyper link, a shortcut (e.g., to execute an application), or the like.

Portable terminals are becoming larger in size. For example, various portable terminals according to the related art have a touchscreen of 6″. Although portable terminals having relatively large touchscreens have several associated benefits, as a touchscreen on a portable terminal is made increasingly larger, navigation and interfacing with the touchscreen with a single hand becomes increasingly more difficult. In addition, navigation and interfacing with a touchscreen on a tablet or the like becomes increasingly difficult when the user is required to hold the tablet with two hands and may thus only navigate and interface with the touchscreen with either of the user's two hands which are occupied holding the tablet. For example, depending on the size of a user's hand and a size of the touchscreen, some items displayed on the UI may be out of reach from the user.

Accordingly, there is a need for an apparatus and method for selecting items displayed on a portable terminal.

The above information is presented as background information only to assist with an understanding of the present disclosure. No determination has been made, and no assertion is made, as to whether any of the above might be applicable as prior art with regard to the present disclosure

### SUMMARY

Aspects of the present disclosure are to address at least the above-mentioned problems and/or disadvantages and to provide at least the advantages described below. Accordingly, an aspect of the present disclosure is to provide an apparatus and method for interacting with items on a portable terminal.

In accordance with an aspect of the present disclosure, a method for interacting with items on a portable terminal is provided. The method includes receiving an input for rearranging at least one item on a User Interface (UI), and rearranging and displaying on a screen the at least one item on the UI. The at least one rearranged item may be rearranged so as to be displayed in a position that is different from an original position of the at least one rearranged item in relation to a remaining portion of the UI.

In accordance with another aspect of the present disclosure, a portable terminal for interacting with items displayed thereon is provided. The apparatus includes a touchscreen configured to detect an input, and to display a User Interface (UI) including at least one item, and a control unit configured to receive an input for rearranging at least one item on UI, and to rearrange and display on the touchscreen the at least one item on the UI. The at least one rearranged item is rearranged so as to be displayed in a position that is different from an original position of the at least one rearranged item in relation to a remaining portion of the UI.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent from the following description taken in conjunction with the accompanying drawings, in which:

FIG. 1 is a diagram illustrating a User Interface (UI) displayed on a portable terminal according to the related art;

FIG. 2 is a diagram illustrating a UI displayed on a portable terminal according to the related art; and

FIG. 3 is a flowchart illustrating a method of arranging a UI displayed on a portable terminal according to the related art;

FIG. 4 is a flowchart illustrating a method of arranging items on a UI displayed on a portable terminal according to an embodiment of the present disclosure;

FIGS. 5A, 5B, 5C, 5D, and 5E are diagrams illustrating a UI displayed on a portable terminal according to an embodiment of the present disclosure;

FIGS. 6A, 6B, 6C, 6D, and 6E are diagrams illustrating a UI displayed on a portable terminal according to various embodiments of the present disclosure; and

FIG. 7 is a block diagram schematically illustrating a configuration of a portable terminal according to an embodiment of the present disclosure

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As a non-exhaustive illustration only, a portable terminal described herein may refer to mobile devices such as a cellular phone, a Personal Digital Assistant (PDA), a digital camera, a portable game console, an MP3 player, a Portable/Personal Multimedia Player (PMP), a handheld e-book, a tablet PC, a portable lap-top PC, a Global Positioning System (GPS) navigation, and the like capable of wireless communication or network communication consistent with that disclosed herein.

As a non-exhaustive illustration only, an item displayed on a User Interface (UI) may refer to an image, a hyperlink, a shortcut (e.g., to execute an application, to playback a media content), a list, and the like. For example, an item may be an element that may be interacted with (e.g., selected) by a user to perform a function associated therewith.

As discussed above, as a touchscreen of a portable terminal increases in size, interacting with the touchscreen becomes increasingly difficult. For example, as the touchscreen increases in size, a user may find interacting with (e.g., selecting) items displayed on the UI difficult, particularly the items displayed at an area of the touchscreen that is furthest from the area of the portable terminal at which the user grips the portable terminal.

According to the related art, a user may input a preconfigured input that is associated with minimizing the UI so as to display on the touchscreen a UI having a size which allows a user to interact with all areas of the UI. For example, the UI is displayed on only a partial area of the touchscreen. However, minimizing the UI has several disadvantages associated therewith. Namely, a user may have difficulty reading the various information and interacting with the various items provided on UIs having reduced size (e.g., a minimized UI). Users generally prefer larger screens (and thus larger UIs) because such screens are easier to read and interact with. Conversely, users may have difficulty reading and interacting with the various items and/or elements provided on smaller UIs.

According to the related art, a terminal may be connected to a keyboard having a plurality of keys. The terminal may be configured to have a mapping by which each item displayed on the screen is associated with a number. The functionality associated with such a mapping may be called by input of a predefined button (e.g., by a user pressing the “f” button). Thereafter, a desired item may be selected through input of the corresponding number mapped to the item. Such a system according to the related art is unduly complex because the system requires a keyboard and has an input complexity equal to the number of elements on screen. For example, if the UI being displayed includes 100 items, then the user would need to initiate the functionality associated with the mapping of items to the plurality of keys, input the number (e.g., a three digit number based on the number of items being displayed being 100) mapped to the item which the user desires to select, and then execute the number. As a result, such a system according to the related art requires five touch events in order to select the desired item. In addition, according to the related art, no unique UI is provided and reading the numbers mapped to each item is very difficult, particularly on a portable terminal. An example of such a related art system is a browser plugin (e.g., a Chrome Vi Plugin). However, such a plugin is not a mobile application.

Various embodiments of the present disclosure include an apparatus and method for interacting with (e.g., selecting) items on a portable terminal According to various embodiments of the present disclosure, the items displayed on a UI (or subset thereof) may be selectively rearranged to allow a user to access or otherwise interact with desired items.

According to various embodiments of the present disclosure, functionality for re-arranging items on the UI may be called according to a set (or otherwise predefined) input. For example, when the set input is input to the portable terminal (e.g., to the touchscreen), the portable terminal may then rearrange items on the UI. According to various embodiments of the present disclosure, when the set input is input to the portable terminal, the UI may prompt the user to select which items to rearrange. According to various embodiments of the present disclosure, the selected items to be rearranged may be arranged on the UI in a position at which the user may interact with the item (e.g., select the item) with relative ease.

According to various embodiments of the present disclosure, items selected to be rearranged on the UI may be arranged at a specific location or area of the UI. For example, the specific location or area of the UI may be selected by the user after the user selects the items to be rearranged. As another example, the specific location or area of the UI at which the items are to be rearranged may be predefined and stored according to user and/or device settings.

According to various embodiments of the present disclosure, the items selected to be rearranged may be arranged according to a predefined configuration. For example, the items selected to be rearranged may be arranged according to item type (e.g., so as to arrange various content types at certain areas of the UI, or so as to arrange the selected items in an order based on content type).

According to various embodiments of the present disclosure, the input for requesting to rearrange selected items on the UI may be configurable by a user and may be stored according to user and/or device settings. According to various embodiments of the present disclosure, the input for requesting to rearrange selected items on the UI may correspond to a drag (e.g., of a finger or other input device such as a stylus, or the like) from a corner of the touchscreen. For example, the drag may be input from the corner of the touchscreen to which the user's hand holding the portable device is closest (e.g., if the user is holding the portable terminal in the user's right hand, then the drag may be input from the bottom right corner of the touchscreen). According to various embodiments of the present disclosure, the input for requesting to rearrange selected items on the UI may correspond to a hover over a predefined area of the touchscreen. For example, the hover may correspond to a user hovering a finger or other input device for a threshold period of time.

According to various embodiments of the present disclosure, when the input for requesting to rearrange selected items on the UI is detected, the portable terminal may activate or otherwise execute functionality with which the user may select items to be rearranged. For example, the portable terminal may display a UI element with which the user may select items to be arranged. The UI element may be an arrow, a spear, a hand, or some other vector with which the user may aim towards items that the user wants to select as items to be arranged. As an example, the user may point the UI element towards items displayed on an opposite side of the touchscreen. In response, the portable terminal may select those items in the path of the UI element or items that are otherwise identified in association with the UI element, and thereafter rearrange the selected items in an area of the UI in which the user may interact with (e.g., select) at least one of the selected items. According to various embodiments of the present disclosure, a user may navigate the UI element across the UI to select items to rearrange.

According to various embodiments of the present disclosure, the portable terminal may display a UI element with which the user may select items to be arranged while the user is still engaging the touch event used for requesting to rearrange the select items on the UI. Accordingly, the user may input an input to request to rearrange selected items and navigate the UI element for selecting the items to be arranged without having to remove the user's finger (or other input means) from the touchscreen.

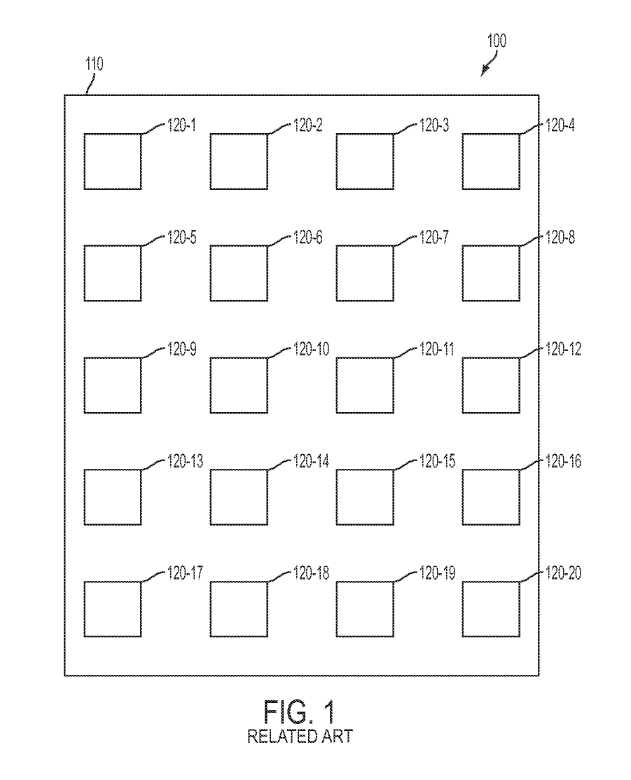

FIG. 1 is a diagram illustrating a User Interface (UI) displayed on a portable terminal according to the related art.

Referring to FIG. 1, a portable terminal 100 displays a UI 110 on a screen of a touchscreen. The UI 110 includes a plurality of items 120-1 through 120-20 with which a user may interact. For example, a user may select at least one of the plurality of items 120-1 through 120-20. Upon selection of the at least one of the plurality of items 120-1 through 120-20, the portable terminal 100 may perform a corresponding function.

As an example, if the UI displays a web page in a browser, then the plurality of items 120-1 through 120-20 may correspond to a hyperlink, an image, the like, or any combination thereof. If the selected at least one of the plurality of items 120-1 through 120-20 corresponds to a hyperlink, then upon selection of the hyperlink, the portable terminal 100 may navigate the browser accordingly.

As another example, if the UI displays a home screen, then the plurality of items 120-1 through 120-20 may correspond to an application icon which, when selected, prompts the portable terminal 100 to execute a corresponding function (e.g., execution of an application, playback of an associated media content, or the like).

According to the related art, if a user holds the portable terminal 100 with the user's right hand at the bottom right corner of the touchscreen, then the user may have difficulty interacting with items at an opposite area of the touchscreen. For example, the user may have difficulty interacting with items 1201-1, 120-2, 120-3, and 120-4 corresponding to the top row of items displayed across the top area of the UI 110. As another example, the user may have difficulty interacting with items 120-1, 120-2, 120-5, and 120-6 corresponding items displayed in the top left corner of the UI 110.

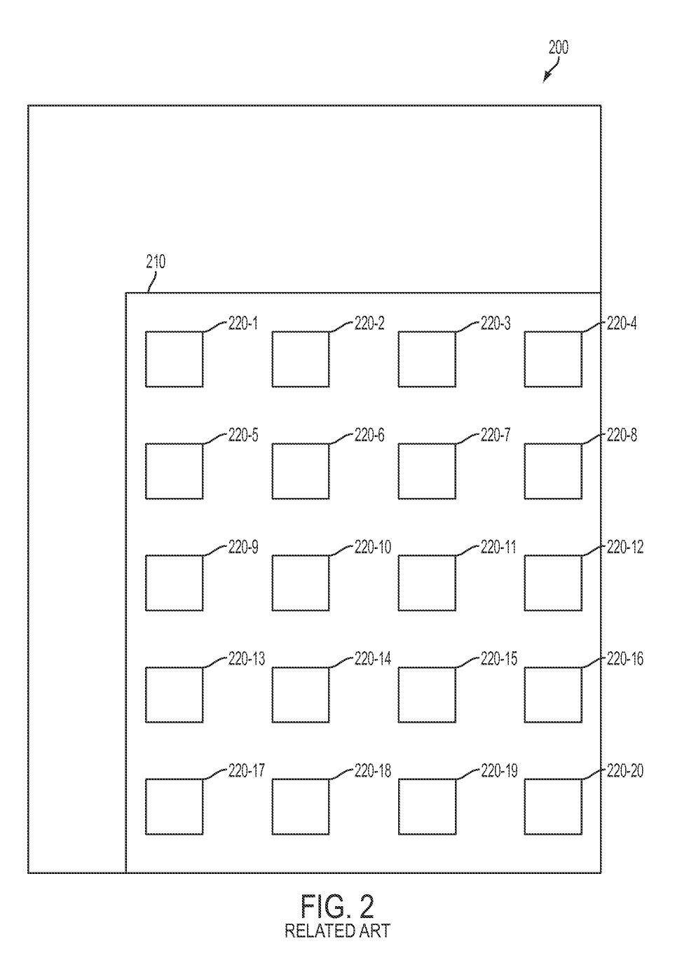

FIG. 2 is a diagram illustrating a UI displayed on a portable terminal according to the related art.

Referring to FIG. 2, a UI 210 may be reduced in size or otherwise minimized so as to only be displayed on a portion of the touchscreen of the portable terminal 200. For example, the UI 210 may be reduced in size so as to be displayed in an area of the touchscreen which is accessible to the user holding the portable terminal 200 and attempting to navigate and interact with the UI 210 using the same hand that is grasping the portable terminal 200. Accordingly, the UI 210 is reduced in size and displayed in a bottom right area of the touchscreen (e.g., assuming that the user holds the portable terminal 200 in the bottom right corner.

As illustrated in FIG. 2, the UI 210 having a reduced size displays the plurality of items 220-1 through 220-20. As an example, the UI 210 having a reduced size as illustrated in FIG. 2 in contrast to UI 110 illustrated in FIG. 1 displays the same number of items and in the same arrangement as the UI 110 having a maximized size.

According to the related art, the portable terminal 200 may display the UI 210 having a reduced size when the user enters a predefined input. Upon detection of the predefined input, the portable terminal 200 displays the UI 210 until the user enters another predefined input associated with specifically maximizing the UI 210 (e.g., so as to be displayed as UI 110 of FIG. 1). In other words, even if the user selects at least one of the plurality of items 220-1 through 220-20, the UI 210 continues to be displayed in a reduced or minimized state (e.g., even if the portable terminal 200 is executing an application associated with the selected at least one of the plurality of items 220-1 through 220-20).

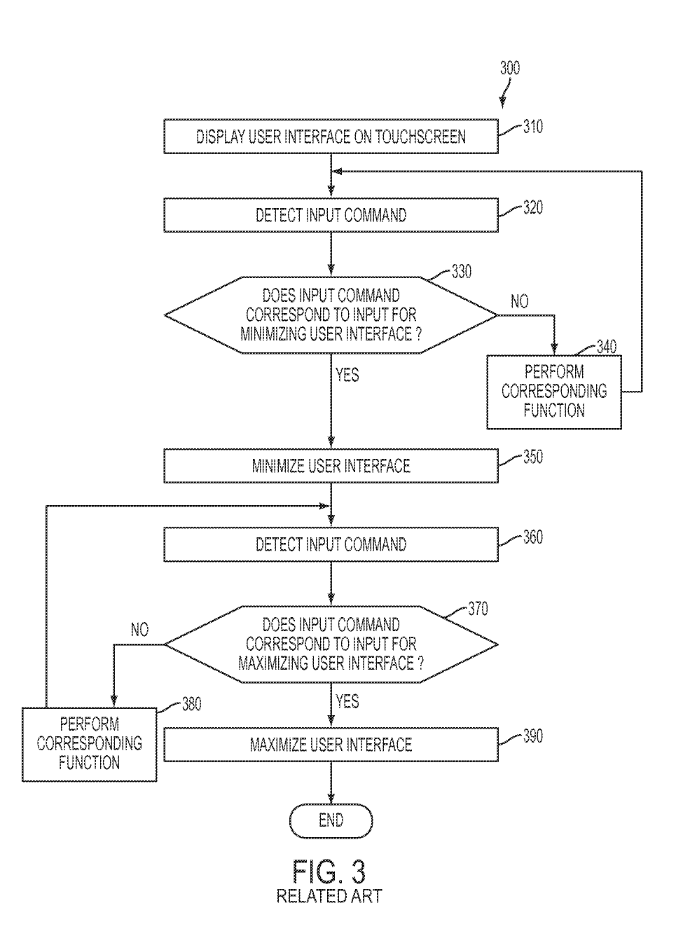

FIG. 3 is a flowchart illustrating a method of arranging a UI displayed on a portable terminal according to the related art.

Referring to FIG. 3, at operation 310, the portable terminal displays a UI on a touchscreen. As discussed above in relation to FIGS. 1 and 2, the UI may display at least one item.

At operation 320, the portable terminal detects an input.

At operation 330, the portable terminal determines whether the detected input corresponds to an input for reducing the UI displayed on the touchscreen. For example, the portable terminal determines whether the detected input corresponds to input of the predefined input associated with reducing (or minimizing) the UI.

If the portable terminal determines that the detected input does not correspond to the input for reducing the UI displayed on the touchscreen at operation 330, then the portable terminal may proceed to operation 340 at which the portable terminal performs a corresponding function (e.g., executes an application associated with the input, plays back a media content selected, or the like). Thereafter, the portable terminal may return to operation 320.

In contrast, if the portable terminal determines that the detected input corresponds to the input for reducing the UI displayed on the touchscreen at operation 330, then the portable terminal proceeds to operation 350 at which the portable terminal reduces the UI displayed on the touchscreen. For example, the portable terminal may reduce the UI 110 illustrated in FIG. 1 so as to display the UI 210 illustrated in FIG. 2. Thereafter, the portable terminal may proceed to operation 360.

At operation 360, the portable terminal may detect an input.

At operation 370, the portable terminal determines whether the input detected at operation 360 corresponds to an input for maximizing the UI. For example, the portable terminal determines whether the input detected at operation 360 corresponds to a request to maximize the UI from the UI 210 of FIG. 2 to the UI 110 of FIG. 1.

If the portable terminal determines that the detected input does not correspond to an input for maximizing the UI at operation 370, then the portable terminal may proceed to operation 380 at which the portable terminal performs a corresponding function (e.g., executes an application associated with the input, plays back a media content selected, or the like). Thereafter, the portable terminal may return to operation 360. As an example, the portable terminal may return to operation 360 may return to operation while the UI being displayed on the touchscreen corresponds to a UI having a relatively reduced size such as, for example, the UI 220 of FIG. 2 (e.g., rather than maximizing the UI upon detection of any input).

In contrast, if the portable terminal determines that the detected input corresponds to an input for maximizing the UI at operation 370, then the portable terminal may proceed to operation 390 at which the portable terminal maximizes the UI. For example, at operation 390, the portable terminal may maximize a UI having a reduced size such as the UI 210 illustrated in FIG. 2 to a UI having a maximized size (e.g., so as to be displayed over the entire surface of the touchscreen) such as the UI 110 illustrated in FIG. 1.

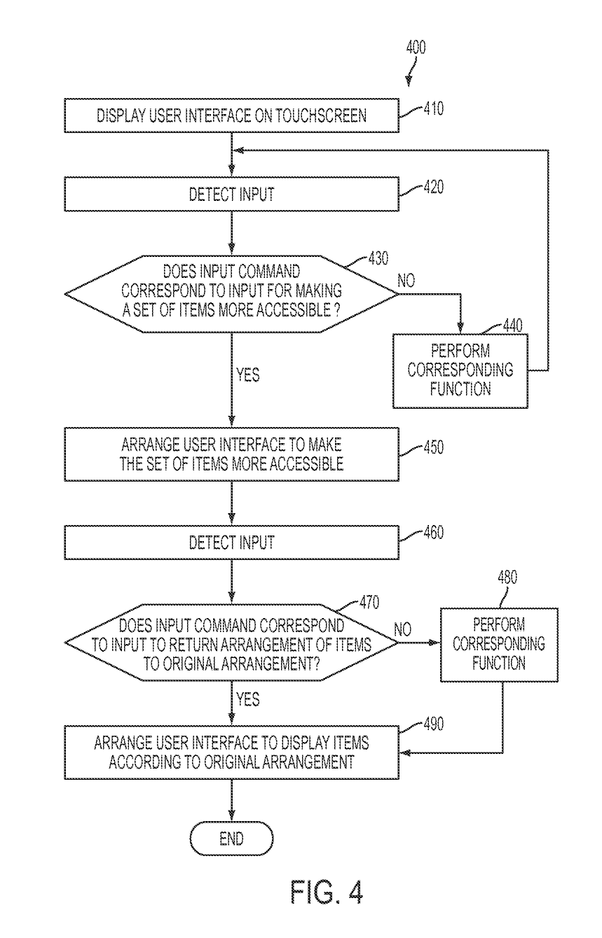

FIG. 4 is a flowchart illustrating a method of arranging items on a UI displayed on a portable terminal according to an embodiment of the present disclosure.

Referring to FIG. 4, at operation 410, the portable terminal displays a UI on a touchscreen. According to various embodiments of the present disclosure, the UI includes at least one item.

At operation 420, the portable terminal detects an input. For example, the input may be a touch on the touchscreen, a hovering event (e.g., hovering a user's finger, input device, or the like above the touchscreen), selection of a button on the portable terminal, or the like. The touch on the touchscreen may correspond to a drag, a touch and hold, and/or the like.

At operation 430, the portable terminal determines whether the detected input corresponds to an input for making a set of items more accessible to the user. For example, the portable terminal determines whether the detected input corresponds to an input for re-arranging a set of items (e.g., so as to be displayed in another/different area of the touchscreen).

According to various embodiments of the present disclosure, an input corresponding to a request for making items more accessible to the user or for rearranging items displayed on the UI may be a touch and hold event at a predefined area of the touchscreen, a hovering event at a predefined area of the touchscreen for a threshold period of time, a drag from a predefined area of the touchscreen to another predefined area of the touchscreen, a draft form a predefined area of the touchscreen for a predefined distance, and/or the like. According to various embodiments of the present disclosure, an input corresponding to a request for making items more accessible to the user or for rearranging items displayed on the UI may be input to a surface of the portable terminal. For example, the input corresponding to a request for making items more accessible to the user or for rearranging items displayed on the UI may be input to a touchscreen. As another example, the input corresponding to a request for making items more accessible to the user or for rearranging items displayed on the UI may be input to a surface other than the touchscreen (or at least a surface other than the display area of the touchscreen). The input corresponding to a request for making items more accessible to the user or for rearranging items displayed on the UI may be an input that is input to a surface other than the touchscreen and dragged to a surface of the touchscreen.

According to various embodiments of the present disclosure, the input corresponding to a request for making items more accessible to the user or for rearranging items displayed on the UI may correspond to a predefined audio input received by a microphone operatively connected or integrated with the portable terminal.

If the portable terminal determines that the detected input does not correspond to an input for making a set of items more accessible to the user at operation 430, then the portable terminal may proceed to operation 440 at which the portable terminal may perform a corresponding function (e.g., executes an application associated with the input, plays back a media content selected, or the like). Thereafter, the portable terminal may return to operation 420.

In contrast, if the portable terminal determines that the detected input corresponds to an input for making a set of items more accessible to the user at operation 430, then the portable terminal proceeds to operation 450 at which the portable terminal arranges the UI to make a set of items more accessible.

According to various embodiments of the present disclosure, when the portable terminal determines that an input is entered wherein the input corresponds to a request to make a set of items more accessible, the portable terminal may prompt the user to select the items to rearrange on the UI (e.g., to a more accessible area of the UI). For example, according to various embodiments of the present disclosure, the portable terminal may display a UI element with which the user may select the at least one item to rearrange on the UI.

According to various embodiments of the present disclosure, a user may navigate the UI element to select the at least one item to be rearranged on the UI. The user may navigate the UI element along a path so as to select items on or around the path. According to various embodiments of the present disclosure, the portable terminal may select items that are on or around the path and a threshold distance from a predefined location on the touchscreen (e.g., the corner at which the user is holding the portable terminal). As a result, items along the path which may already be accessible to the user are not unnecessarily rearranged for accessibility purposes. According to various embodiments of the present disclosure, the threshold distance for which determination as to whether an item should be selected as an item to be rearranged may be configured by a user and stored in user and/or device settings. User configuration of the threshold distance allows users with smaller hands and thus smaller reach to identify and select items closer to the predefined position than a user with relatively larger hands (and relatively longer reach) would otherwise require or prefer.

According to various embodiments of the present disclosure, the user may provide an indication (e.g., through another predefined input) that the user has completed selecting the at least one item to rearrange on the UI.

According to various embodiments of the present disclosure, after the user has selected the at least one item to rearrange on the UI, the portable terminal may arrange the selected at least one item on an area of the UI which allows the user to interact with at least one of the at least one selected item. For example, the portable terminal may display the selected at least one item at a specific location or area of the UI. For example, the portable terminal may display the selected at least one item along at least one of the horizontal or vertical edge of the UI that is closest to the user's hand. As an example, if the user holds the portable terminal with the user's right hand, and the user hold the portable closest to the bottom right corner of the touchscreen, then the portable terminal may arrange the selected at least one item to be displayed along the right edge of the UI, and/or along the bottom edge of the UI.

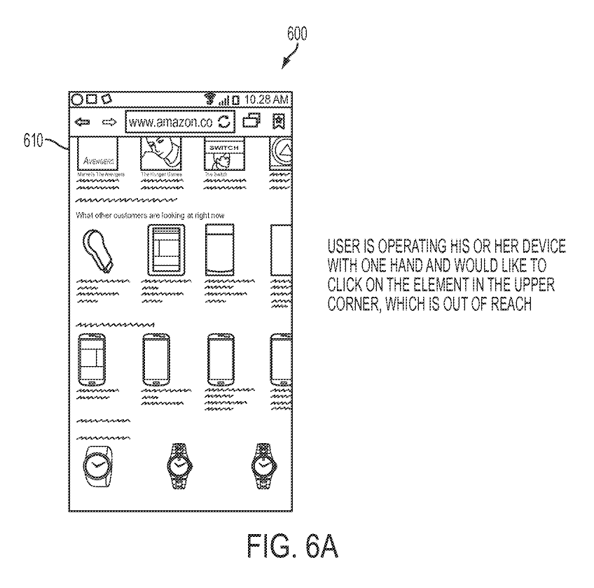

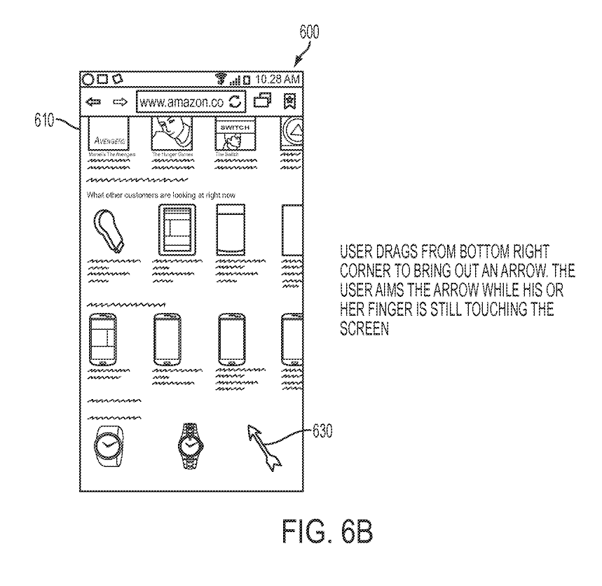

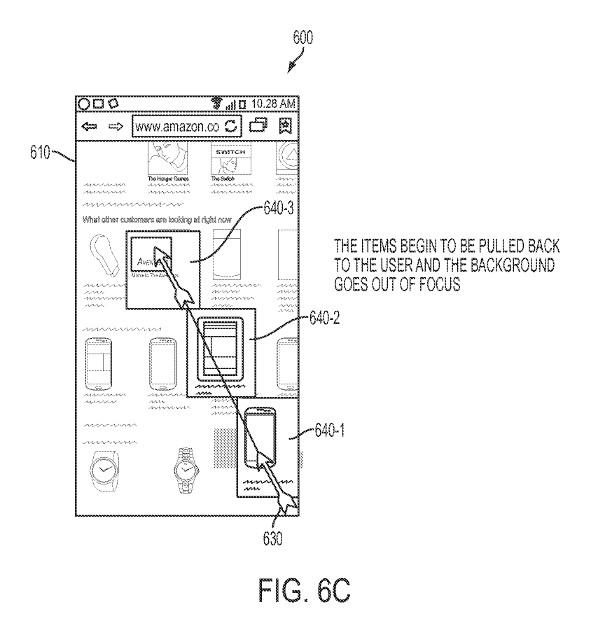

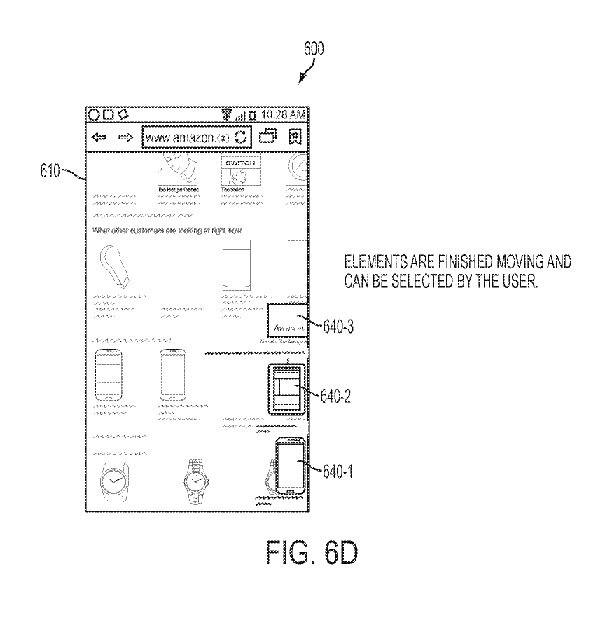

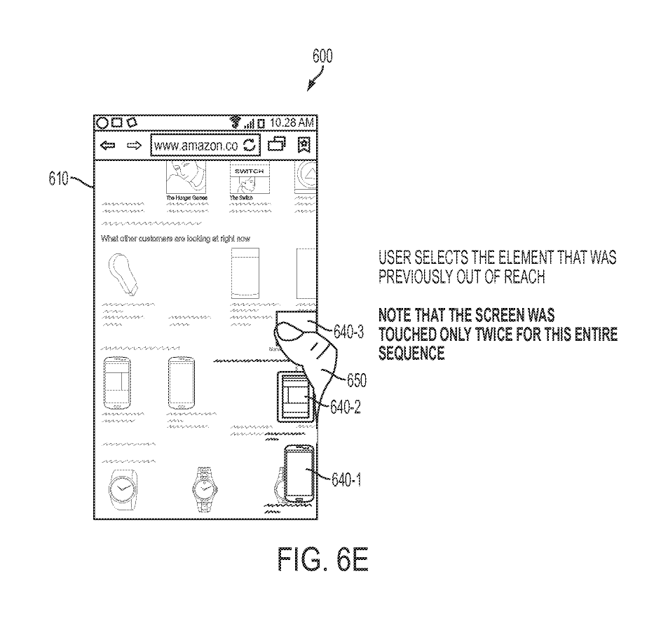

As another example, the UI may display the selected at least one item so as to be displayed emphatically in relation to any items not selected. The selected at least one item may be displayed so as to be overlaid in relation to an item that is not selected. The selected at least one item may be displayed brighter than any items not selected. For example, the UI may display portions of the UI that do not correspond to the selected at least item so as to be shaded in relation to the selected at least one item (e.g., as illustrated in FIG. 6D).

At operation 460, the portable terminal may detect an input. For example, the input may be a touch on the touchscreen, a hovering event (e.g., hovering a user's finger, input device, or the like above the touchscreen), selection of a button on the portable terminal, or the like.

At operation 470, the portable terminal determines whether the input command corresponds to an input requesting the portable terminal to return the arrangement of items displayed on the UI to an original arrangement.

If the portable terminal determines that the input detected at operation 460 corresponds to a request for the portable terminal to return the arrangement of items displayed on the UI to an original arrangement at operation 470, then the portable terminal returns to operation 490 at which the portable terminal arranges the UI to display items according to an original arrangement (e.g., the arrangement of items before the rearrangement of items selected at operation 430). Thereafter, the portable terminal may end the process.

In contrast, if the portable terminal determines that the input detected at operation 460 does not correspond to a request for the portable terminal to return the arrangement of items displayed on the UI to the original arrangement at operation 470, then the portable terminal may proceed to operation 480 at which the portable terminal performs a corresponding function. For example, if the detected input corresponds to interaction with (e.g., selection of) an item displayed on the UI (e.g., selection of one of the items that was rearranged at operation 450), then the portable terminal may perform a function associated with that item (e.g., executes an application associated with the input, plays back a media content selected, or the like). Thereafter, the portable terminal may proceed to operation 490. However, according to various embodiments of the present disclosure, the portable terminal may proceed to operation 460 after operation 480.

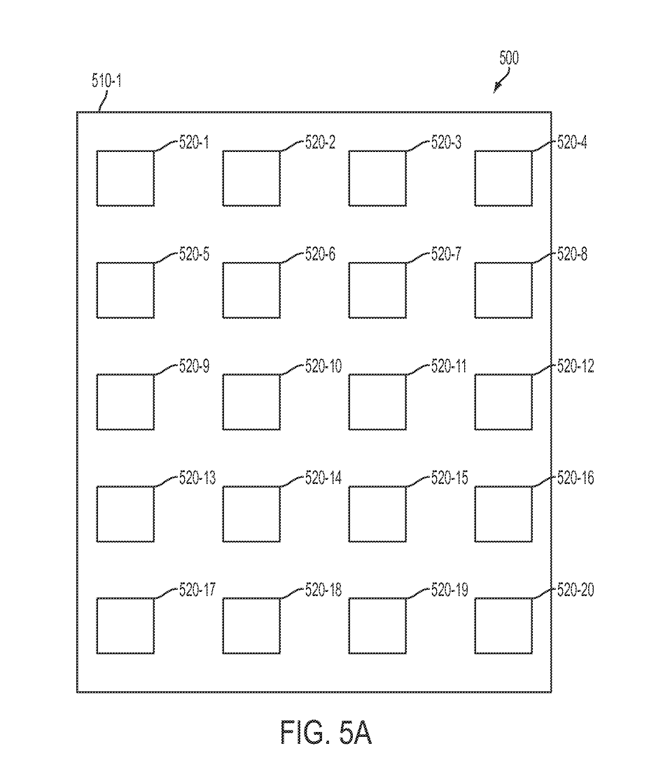

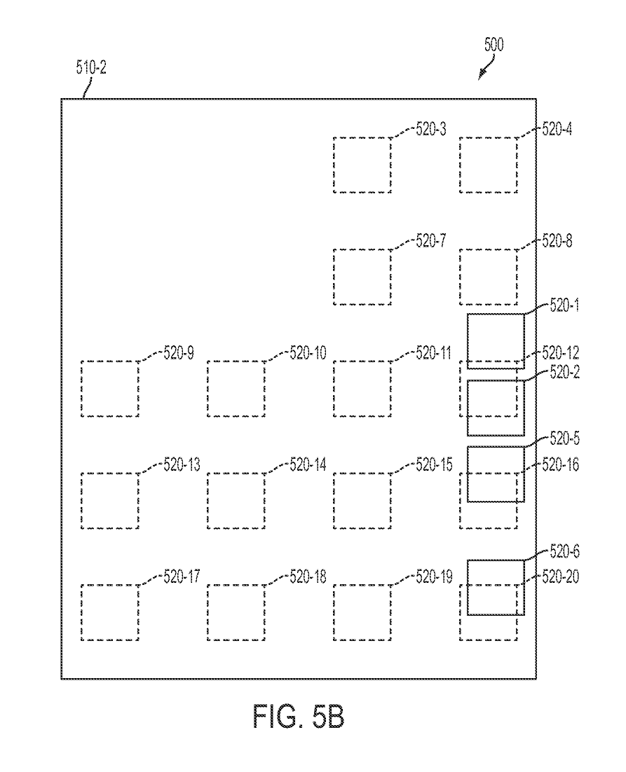

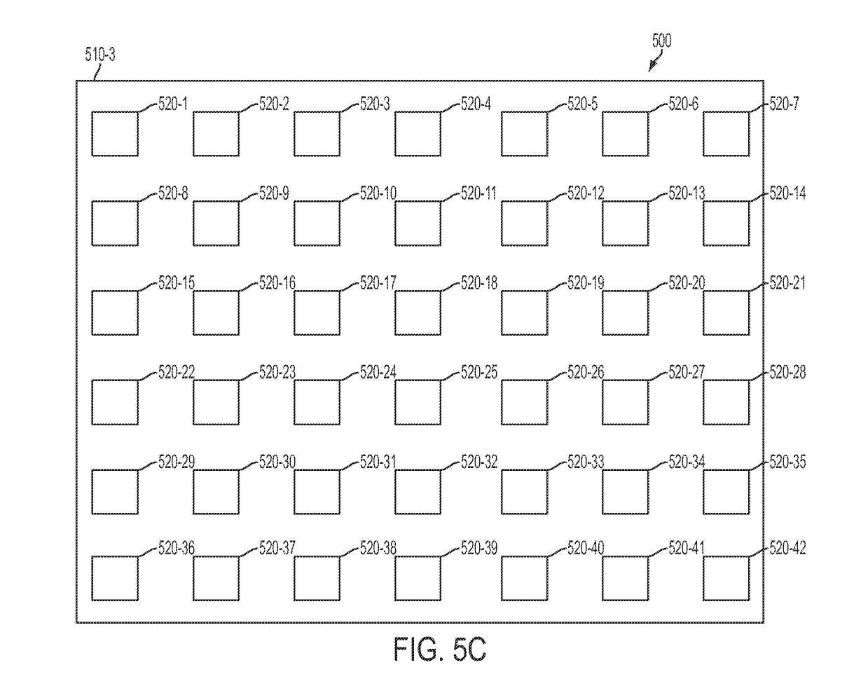

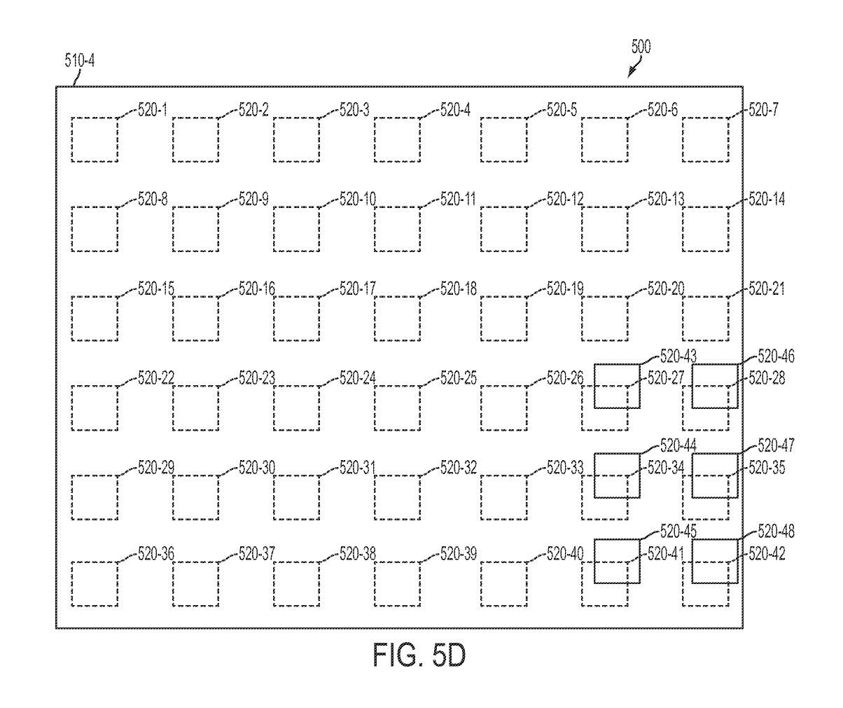

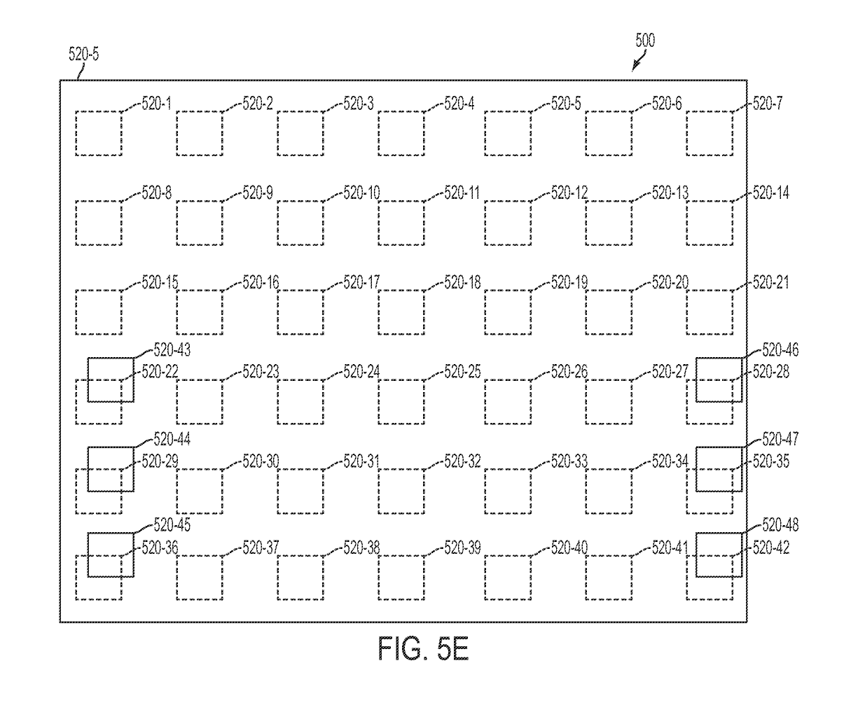

FIGS. 5A and 5B are diagrams illustrating a UI displayed on a portable terminal according to an embodiment of the present disclosure.

Referring to FIG. 5A, the portable terminal 500 displays a UI 510-1. The UI 510-1 includes a plurality of items 520-1 through 520-20. As an example, a user may interact with (e.g., select) at least one of the plurality of items 520-1 through 520-20. Upon interaction with (e.g., selection of) the at least one of the plurality of items 520-1 through 520-20, the portable terminal 100 may perform a corresponding function.

Referring to FIG. 5B, the portable terminal 500 displays a UI 510-2. According to various embodiments of the present disclosure, the portable terminal may rearrange at least one item so as to make the UI more accessible to a user. The UI 510-2 is illustrated under the assumption that the user is right-handed and is holding the portable terminal 500 at the bottom right of the touchscreen. In addition, UI 510-2 is illustrated under the assumption that items 510-1, 520-2, 520-5, and 520-6 have been identified as items that the user wishes to rearrange or that the portable terminal determines are preferred items to rearrange. For example, as illustrated in FIG. 5B, the portable terminal rearranged the plurality of items 520-1 through 520-20 so as to display items 510-1, 520-2, 520-5, and 520-6 so as to be arranged closer to the bottom right corner of the touchscreen. In addition, items 510-1, 520-2, 520-5, and 520-6 which are rearranged so as to be more accessible to the user are displayed so as to be displayed emphatically in relation to the remaining items of the plurality of items 510-1 through 520-20, and so as to be overlaid in relation to items 520-12, 520-16, and 520-20.

Although various embodiments of the present disclosure are described in the context of a user holding and interacting with a UI with a single hand, various embodiments of the present disclosure may relate to the arrangement of items on a portable device with which the user holds with two hands each of which may interact with the UI while grasping the portable terminal. An example according to which the user may hold the portable terminal with two hands and may use either (or both) hand to interact with the UI while holding the terminal with such a hand is when a user is holding and interacting with a tablet.

According to various embodiments of the present disclosure, the user may launch functionality for rearranging items provided off-screen (e.g., that a user would otherwise have to scroll to in order to provide display thereof on the UI). The rearranged items that would otherwise be off-screen items may be displayed so as to be overlaid in relation to other items on the UI. For example, if a user is holding a tablet with both hands, the user may not have a hand available to scroll to off-screen items. Accordingly, the user may launch a functionality for rearranging off-screen items so as to be displayed on the UI.

Referring to FIG. 5C, a portable terminal 500 having a relatively large touchscreen is displayed. The portable terminal 500 displays a UI 510-3. The UI 510-3 includes a plurality of items 520-1 through 520-42. As an example, a user may interact with (e.g., select) at least one of the plurality of items 520-1 through 520-42.

Referring to FIG. 5D, the portable terminal 500 displays a UI 510-4. According to various embodiments of the present disclosure, the portable terminal may rearrange at least one item so as to make the UI more accessible to a user. For example, the rearranged at least one item may correspond to items that are off-screen items which would otherwise require a user to scroll to access or would otherwise need to interact with the UI to display such off-screen items. As illustrated in FIG. 5D, the UI 510-4 displays items 520-43 through 520-48 so as to arrange such off-screen items in an accessible manner. For example, a user may select such off-screen items 520-43 through 520-48 to be rearranged, and upon such selection, the portable terminal 500 may display the rearranged off-screen items 520-43 through 520-48 so as to be displayed emphatically in relation to other items displayed on the UI 520-4. For example, contrasting UI 520-3 illustrated in FIG. 5C with UI 520-4 illustrated in FIG. 5D, all items 520-1 through 520-42 displayed on the UI 520-3 are included in 520-4. However, UI 520-4 further includes off-screen items 520-43 through 520-48. The rearranged off-screen items 520-43 through 520-48 may be displayed so as to be overlaid in relation to items 520-1 through 520-42.

Referring to FIG. 5E, another example of rearranging items is provided. For example, FIG. 5E illustrates a subset of the rearranged items (e.g., items 520-43 through 520-45) being disposed on one side of the UI 520-5 and another subset of rearranged items (e.g., items 520-46 through 520-48) being disposed on another side of the UI 520-5. According to such a rearrangement of items on UI 520-5, a user that holds the portable terminal 500 with two hands may interact with each subset of rearranged items with a corresponding hand (e.g., without having to release hold of the portable terminal 500 with that hand).

As illustrated in FIG. 5E in contrast to FIG. C, the rearranged items 520-43 through 520-48 may correspond to items not originally displayed on UI 520-3. For example, the rearranged items 520-43 through 520-48 may correspond to off-screen items. The off-screen items may correspond to items that a user would have to interact with the UI to access (e.g., the user may have to scroll to the off-screen items in order to interact therewith).

FIGS. 6A, 6B, 6C, 6D, and 6E are diagrams illustrating a UI displayed on a portable terminal according to various embodiments of the present disclosure.

Referring to FIG. 6A, the portable terminal 600 displays UI 610. As an example, the UI may display a web browser as illustrated in FIG. 6A. UI 610 includes a plurality of items, including images and hyperlinks.

According to various embodiments of the present disclosure, an item of the plurality of items included on the UI may be inaccessible to a user. For example, if the user holds the portable terminal 600 at the bottom right hand corner thereof with the user's right hand, then the user may be unable to easily access or otherwise interact with an item provided at an opposing side or location of the UI 610. Indeed, according to such an example, the user may be unable to access or otherwise interact with an item provided at the top left hand corner of the UI 610, an item provided at the top edge of the UI 610, an item provided at the left edge of the UI 610, and the like. Therefore, according to various embodiments of the present disclosure, the user may input a command to launch a functionality for making an item (or set thereof) more accessible to the user. For example, the user may input the command corresponding to a request for making items more accessible to the user or for rearranging items displayed on the UI 601. According to various embodiments of the present disclosure, the input may be a touch and hold event at a predefined area of the touchscreen, a hovering event at a predefined area of the touchscreen for a threshold period of time, a drag from a predefined area of the touchscreen to another predefined area of the touchscreen, a draft form a predefined area of the touchscreen for a predefined distance, and/or the like.

Referring to FIG. 6B, the portable terminal 600 displays UI 610. In addition to including the plurality of items with which the user may access or otherwise interact, the UI 610 also includes a UI element 630 with which the user may select items to be arranged.

As illustrated in FIG. 6B, the UI element 630 may be an arrow. However, according to various embodiments of the present disclosure, the UI element 630 may be a spear, a hand, or some other vector with which the user may aim towards items that the user wants to select as items to be rearranged.

According to various embodiments of the present disclosure, the user may use the UI element 630 to select items to be arranged (e.g., to select items that are inaccessible to the user and which the user wants to rearrange so as to position the items at a location on the UI at which the user may access or otherwise interact with the rearranged items). The user may select items to be arranged using the UI element 630 by aiming the UI element 630 towards the items to be arranged, or may otherwise provide input to the portable terminal which allows the user to navigate the UI element 630 across the UI 610 so as to select the items to be arranged. For example, the user may navigate the UI element 630 so as to create a path on the UI 610. According to various embodiments of the present disclosure, any item along the path may be identified and thus selected as an item to be arranged. According to various embodiments of the present disclosure, any item within a threshold distance of the path may be identified and thus selected as an item to be arranged. According to various embodiments of the present disclosure, the user may identify and thus select an item to be arranged by entering an input at a desired item as the UI element 630 is used to make a path across the UI 610.

Referring to FIG. 6C, the UI element 630 has been navigated to select items to be arranged 640-1, 640-2, and 640-3 provided on the UI 610.

According to various embodiments of the present disclosure, the selected items to be arranged 640-1, 640-2, and 640-3 may be displayed emphatically in relation to other items (e.g., non-selected items) and/or in relation to other features displayed on the UI 610. According to various embodiments of the present disclosure, the non-selected items and other features displayed on the UI 610 may be displayed so as to be shaded in relation to the selected items to be arranged 640-1, 640-2, and 640-3.

According to various embodiments of the present disclosure, the selected items to be arranged 640-1, 640-2, and 640-3 may be moved on the UI 610 so as to be closer to the user. For example, as illustrated in FIG. 6C in contrast to FIG. 6B, the selected items to be arranged 640-1, 640-2, and 640-3 have been moved closer to the bottom right corner of the UI 610 as the UI element 630 selects the respective items.

Referring to FIG. 6D, the selected items to be arranged 640-1, 640-2, and 640-3 may be arranged on the UI 610 so as to be more accessible. As illustrated in FIG. 6D, the selected items to be arranged 640-1, 640-2, and 640-3 are arranged along the bottom right edge of the UI 610. According to various embodiments of the present disclosure, the selected items to be arranged 640-1, 640-2, and 640-3 may be arranged on the UI 610 when the user has completed selecting items to be arranged using the UI element 630.

The portable terminal 600 may display the selected items to be arranged 640-1, 640-2, and 640-3 at a specific location or area of the UI 610. According to various embodiments of the present disclosure, the specific location or area of the UI 610 at which the selected items to be arranged 640-1, 640-2, and 640-3 are displayed may be preconfigured. According to various embodiments of the present disclosure, the user may select the specific location or area of the UI 610 at which the arranged the selected items upon launching of the functionality for making an item (or set thereof) more accessible to the user. According to various embodiments of the present disclosure, the user may select the specific location or area of the UI 610 at which the arranged the selected items upon completion of selecting the items to be arranged.

Referring to FIG. 6E, the user 650 may interact with (e.g., select) one of the plurality of items included on the UI 610. For example, the user 650 may interact with (e.g., select) one of the items rearranged 640-1, 640-2, and 640-3.

According to various embodiments of the present disclosure, the UI 610 may allow the user 650 to only interact with (e.g., select among) the rearranged items 640-1, 640-2, and 6403. According to various embodiments of the present disclosure, the UI 610 may allow the user 650 to only interact with (e.g., select among) all of the plurality of items provided on the UI 610.

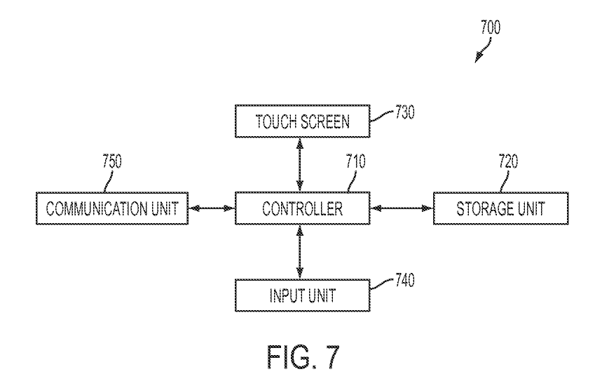

FIG. 7 is a block diagram schematically illustrating a configuration of a portable terminal according to an embodiment of the present disclosure.

Referring to FIG. 7, the portable terminal 700 includes at least one controller 710, a storage unit 720, a touchscreen 730, and an input unit 740. The portable terminal 700 may also include a communication unit 750.

According to various embodiments of the present disclosure, the portable terminal 700 comprises at least one controller 710. The at least one controller 710 may be configured to operatively control the portable terminal 700. For example, the at least one controller 710 may control operation of the various components or units included in the portable terminal 700. The at least one controller 710 may transmit a signal to the various components included in the portable terminal 700 and control a signal flow between internal blocks of the portable terminal 700. In particular, according to various embodiments of the present disclosure, the at least one controller 710 may perform an action (e.g., a command, function, or the like) according to an input. For example, the at least one controller 710 may rearrange an item on a UI according to user input. The at least one controller 710 may select items to be rearranged on a UI according to user input. The at least one controller 710 may rearrange items selected to be rearranged. In addition, the at least one controller 710 may perform a corresponding function associated with an application with which a user interacted (e.g., selected).

The storage unit 720 can store user data, and the like, as well a program which performs operating functions according to various embodiments of the present disclosure. The storage unit 720 may include a non-transitory computer-readable storage medium. As an example, the storage unit 720 may store a program for controlling general operation of a portable terminal 700, an Operating System (OS) which boots the portable terminal 700, and application program for performing other optional functions such as a camera function, a sound replay function, an image or video replay function, a signal strength measurement function, a route generation function, image processing, and the like. Further, the storage unit 720 may store user data generated according to a user of the portable terminal 700, such as, for example, a text message, a game file, a music file, a movie file, and the like. In particular, according to various embodiments of the present disclosure, the storage unit 720 may store an application or a plurality of applications that individually or in combination select items to be rearranged on a UI according to user input, rearrange items selected to be rearranged, perform a corresponding function associated with an application with which a user interacted (e.g., selected).

The touchscreen 730 displays information inputted by user or information to be provided to user as well as various menus of the portable terminal 700. For example, the touchscreen 730 may provide various screens according to a user of the portable terminal 700, such as an idle screen, a message writing screen, a calling screen, and the like. In particular, according to various embodiments of the present disclosure, the touchscreen 730 may display an image and/or UI from which the user may interact with (e.g., select) a command and/or an item. According to various embodiments of the present disclosure, the user may enter to the touchscreen 730 an input for requesting to rearrange selected items on the UI, an input for selecting items to be rearranged, an input to select an item for which a corresponding function is desired, and/or the like. According to various embodiments of the present disclosure, the touchscreen 730 may display an interface which the user may manipulate or otherwise enter inputs via a touchscreen to enter selection of various functions of the portable terminal 700. The touchscreen 730 can be formed as a Liquid Crystal Display (LCD), an Organic Light Emitting Diode (OLED), an Active Matrix Organic Light Emitting Diode (AMOLED), and the like. However, various embodiments of the present disclosure are not limited to these examples. Further, the touchscreen 730 can perform the function of the input unit 740.

The input unit 740 may include input keys and function keys for receiving user input. For example, the input unit 740 may include input keys and function keys for receiving an input of numbers or various sets of letter information, setting various functions, and controlling functions of the portable terminal 700. For example, the input unit 740 may include a calling key for requesting a voice call, a video call request key for requesting a video call, a termination key for requesting termination of a voice call or a video call, a volume key for adjusting output volume of an audio signal, a direction key, and the like. In particular, the input unit 740 according to various embodiments of the present disclosure may transmit to the controller 710 signals related to the request to select rearrange items on the UI, signals related to selection of the items to rearrange on the UI, signals related to the interaction with (e.g., selection of) items for which a corresponding function is desired, and/or the like. Such an input unit 740 may be formed by one or a combination of input means such as a touch pad, a touchscreen, a button-type key pad, a joystick, a wheel key, and the like.

The communication unit 750 may be configured for communicating with other devices. For example, the communication unit 750 may be configured to communicate via Bluetooth technology, WiFi technology, or another wireless technology.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for interacting with items on a portable terminal, the method comprising:
receiving an input for rearranging at least one item on a User Interface (UI); and
rearranging and displaying on a screen the at least one item on the UI,
wherein the at least one rearranged item is rearranged so as to be displayed in a position that is different from an original position of the at least one rearranged item in relation to a remaining portion of the UI.

2. The method of claim 1, wherein the at least one item on the UI is rearranged according to the input for rearranging at least one item.

3. The method of claim 1, further comprising:
upon receipt of the input for rearranging the at least one item, displaying a UI element on the UI with which the at least one item to be rearranged is selected.

4. The method of claim 3, further comprising:
selecting the at least one item to be rearranged.

5. The method of claim 4, further comprising:
upon the at least one item selected to be rearranged being selected, displaying the at least one item selected to be rearranged emphatically in relation to other items on the UI.

6. The method of claim 4, further comprising:
upon the at least one item selected to be rearranged being selected, rearranging and displaying on a screen the at least one item on the UI so as to display the at least one rearranged item according to a preconfigured arrangement on the UI.

7. The method of claim 4, further comprising:
upon the at least one item selected to be rearranged being selected, rearranging and displaying on a screen the at least one item on the UI so as to display the at least one rearranged item at a preconfigured area of the UI.

8. The method of claim 4, wherein the screen is a touchscreen, and
wherein the input for rearranging the at least one item on the UI and the selection of the at least one item to be arranged are made with a single touch event to the touchscreen.

9. The method of claim 1, wherein the position at which the at least one rearranged item is displayed on the UI is more accessible to a user than the original position of the at least one rearranged item.

10. The method of claim 1, wherein the position the position at which the at least one rearranged item is displayed on the UI is closer to a hand of a user with which the user is holding the portable terminal.

11. A non-transitory computer-readable storage medium storing instructions that, when executed, cause at least one processor to perform the method of claim 1.

12. A portable terminal for interacting with items displayed thereon, the apparatus comprising:
a touchscreen configured to detect an input, and to display a User Interface (UI) including at least one item; and
a control unit configured to receive an input for rearranging at least one item on UI, and to rearrange and display on the touchscreen the at least one item on the UI,
wherein the at least one rearranged item is rearranged so as to be displayed in a position that is different from an original position of the at least one rearranged item in relation to a remaining portion of the UI.

13. The portable terminal of claim 12, wherein the control unit rearranges the at least one item on the UI according to the input for rearranging at least one item.

14. The portable terminal of claim 12, wherein, upon receipt of the input for rearranging the at least one item, the control unit controls the touchscreen to display a UI element on the UI with which the at least one item to be rearranged is selected.

15. The portable terminal of claim 14, wherein the control unit is further configured to operatively receive selection of the at least one item to be rearranged.

16. The portable terminal of claim 15, wherein, upon the at least one item selected to be rearranged being selected, the control unit controls the touchscreen to display the at least one item selected to be rearranged emphatically in relation to other items on the UI.

17. The portable terminal of claim 15, wherein upon the at least one item selected to be rearranged being selected, the control unit controls to rearrange and display on the touchscreen the at least one item on the UI so as to display the at least one rearranged item according to a preconfigured arrangement on the UI.

18. The portable terminal of claim 15, wherein, upon the at least one item selected to be rearranged being selected, the control unit controls to rearrange and display on the touchscreen the at least one item on the UI so as to display the at least one rearranged item at a preconfigured area of the UI.

19. The portable terminal of claim 15, wherein the input for rearranging the at least one item on the UI and the selection of the at least one item to be arranged are made with a single touch event to the touchscreen.

20. The portable terminal of claim 12, wherein the position at which the at least one rearranged item is displayed on the UI is more accessible to a user than the original position of the at least one rearranged item.

21. The method of claim 12, wherein the position the position at which the at least one rearranged item is displayed on the UI is closer to a hand of a user with which the user is holding the portable terminal.

22. A method for interacting with items on a portable terminal, the method comprising:
receiving an input for rearranging at least one item on a User Interface (UI);
displaying a UI element with which user selects at least one item to be rearranged on the UI; and
rearranging and displaying on a screen the at least one item on the UI according to a preconfigured arrangement and so as to be displayed emphatically in relation to other items on the UI.
